(19) United States
(12) Patent Application Publication
(10) Pub. No.: US 2008/0162144 A1
(43) Pub. Date: Jul. 3, 2008

(54) System and Method of Voice Communication with Machines

(75) Inventors: Anjaneyulu Seetha Rama Kuchibhotla, Bangalore Karnataka (IN); Vishal Kasera, San Francisco, CA (US); Srinivasan Ramani, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/883,763

(22) PCT Filed: Feb. 23, 2005
(86) PCT No.: PCT/IN2005/000057

§ 371 Date: Aug. 6, 2007

(51) Int. Cl. G10L 21/00

(52) U.S. Cl. 704/275; 704/E15.001

(57) ABSTRACT

A system and method of voice communication with a machine are provided. The system includes a guide for containing at least one input element disposed in an arrangement, the arrangement having a coordinate system for locating the input element, and a processor for processing a user selection of the input element.

### FIELD OF INVENTION

The present invention relates generally to voice communications with machines. More particularly, the present invention relates to voice communication with a machine based on a guide containing input elements.

### BACKGROUND OF INVENTION

There are various ways for communicating with a machine such as a computer. Widely used ways include using QWERTY keyboards and mice. A limitation with QWERTY keyboard is that it is more difficult to accommodate non-roman alphabet languages due to the huge number of alternatives and variations of characters.

Another way for communicating with a machine is by using voice utterances or commands. However, even with current advances in speech processing technologies, it is still a challenge to process voice utterances from different users having varying pronunciations while catering for large vocabularies with high degrees of accuracy. Further, speech recognition capability does not exist for several languages. Current speech recognition systems favor voice commands that are very distinct and typically perform efficient voice recognition when the pre-defined voice database is relatively small or if significant data collection is carried out. Further, in many parts of the world, a significant proportion of the population is illiterate. Many of these people can only speak colloquially and often rely heavily on visual aides such as signs and pictures for communication. These limitations inhibit a large group of people from benefiting from the use of electronic devices and voice services in their daily living. This is increasingly becoming a problem as the use of technologies becomes the norm in a progressive society.

Accordingly, there is a need to provide a simple alternative for users to interact with electronic devices using substantially limited voice commands.

### SUMMARY OF INVENTION

A system and method of voice communication with a machine are provided. The system includes a guide for containing at least one input element disposed in an arrangement, the arrangement having a coordinate system for locating the input element, and a processor for processing a user selection of the input element.

### BRIEF DESCRIPTION OF DRAWINGS

Embodiments of the invention are herein described, purely by way of example, with reference to the accompanying drawings, in which:

FIG. 1 shows a flowchart of a method of voice communication with a machine according to an embodiment of the invention;

FIGS. 2(A-D) show examples of input elements disposed in matrices according to embodiments of the invention;

FIG. 3 shows a block diagram of a system for enabling voice communication with a machine according to an embodiment of the invention; and

FIG. 4 shows a block diagram of a system for enabling voice communication with a machine according to an alternative embodiment of the invention.

### DETAILED DESCRIPTION OF INVENTION

A system and method of voice communication with a machine according to embodiments of the invention are described hereinafter with reference to the accompanying drawings. The system and method enable users to effectively communicate with the machine by using voice utterances or commands to select an input element from a guide containing one or more input elements. The input elements can include alphabet, words, symbols, pictures, signs, computer control commands, and the like various ways of presenting information and combinations thereof.

In an embodiment, the system and method use a relatively small number of voice commands (i.e. vocabulary) for selecting the input elements from the guide. The system includes a small list of pre-defined labels. The pre-defined labels are used as indices of a coordinate system for locating the input elements which are arranged in a table or matrix in the guide. The pre-defined labels include a text form (typically used for displaying) and an audio form, wherein each text form label corresponds to an audio form label. The pre-defined labels can be in the form of colors, numbers, characters, words, images, symbols, and the like easy to recognize and distinguish forms of reference that can be represented as audio input.

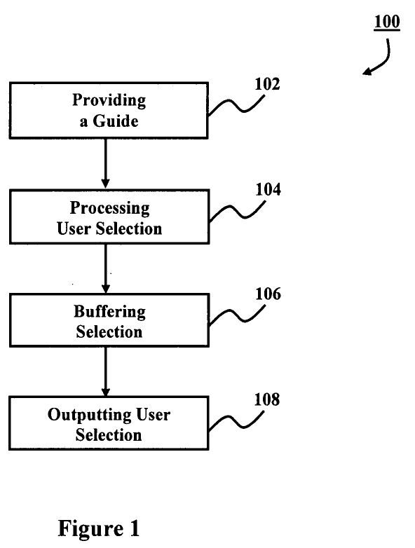

A method 100 of effective voice communication with a machine according to an embodiment is shown in FIG. 1. In a step 102 of the method 100, a guide for containing input elements are provided. The input elements can be alphabet, words, symbols, pictures, signs, commands (for example, for controlling the machine), or the like input elements and combinations thereof. The input elements are provided to the users in a table or matrix for the users to select from.

Step 104 involves receiving audio input of the coordinates from the user and decoding the indices of the coordinates to determine the input element the user desires to select. The process of decoding the indices involves comparing the audio characteristic of the indices against the pre-defined labels using an audio recognizer. Once the indices are determined, these are used as search parameters for identifying the selected input element according to a display data structure. The display data structure is also created to keep track of the location of each of the input elements in the matrix. The display data structure stores the location of the input elements using either text form labels or audio form labels.

Upon finding the desired input element, the selected input element can be buffered in a step 106 for further processing depending on the intended user application. The selected input element can also be output to the user as a feedback mechanism in step 108. In step 108, the selected input element can be output to a display or by playing back the audio of the selected input element or a combination of both.

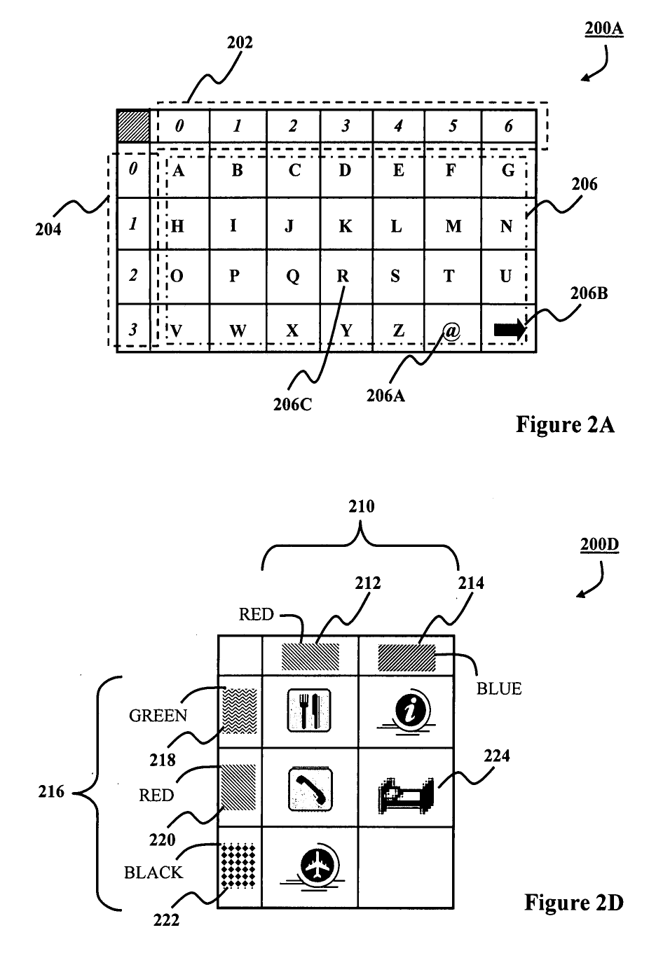

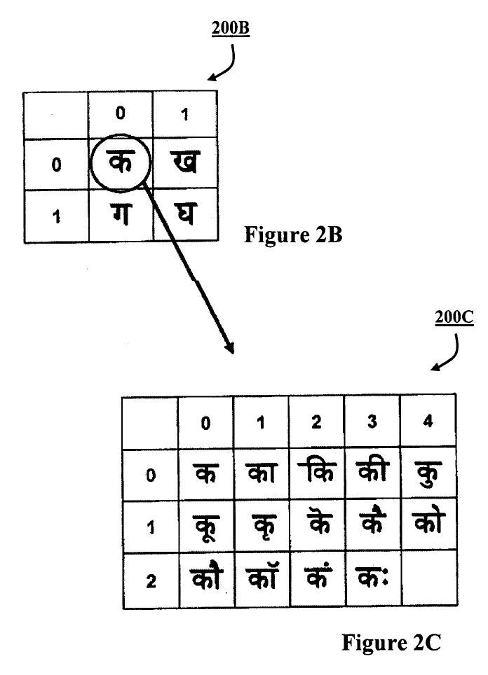

An example of the input elements is shown in FIG. 2A, wherein the input elements 206 are arranged in a matrix 200A. The matrix 200A includes a column-index 202 and a row-index 204. As seen in FIG. 2A, the indices (i.e. pre-defined labels) of the column-index and row-index are ordinary numbers. It should be noted that cardinal numbers can also be used. The user can select an input element by uttering the coordinates of the input element into a microphone (not shown) coupled to the machine. For example, if the user desires to select the input element “@”206A, the coordinates (5, 3) can be uttered (i.e. the user says the number 5 followed by the number 3) and the selection is processed in step 106 of the method 100.

In the above example, if the matrix is not large enough to accommodate all the possible input elements in one guide, a “next screen” element 206B (as seen in FIG. 2A) can be provided. Thus, if the user utters the coordinates (6, 3), which corresponds to the “next screen” element 206B, a new guide is provided and a new or second display data structure is created to keep track of the input elements of the new matrix in the new guide.

In an embodiment, if a user is interested in seeking information relating to an input element, a new matrix containing information relating to the selected input element can be provided. For example, the user is interested in words starting with the letter “R” 206C. Upon uttering the coordinates (3, 2), a new matrix can be displayed containing words starting with the letter “R”. The words displayed can also be accompanied by pictures and sounds for added information. Further, this feature is useful for composing text messages in languages such as Hindi, Thai, and the like written languages where generic characters can be augmented with accent marks or post-character modifier strokes to form a complete word. Thus, the first or primary matrix can contain the generic characters and the secondary matrix can contain enhanced or variations of the selected generic character.

A further example can be seen in FIGS. 2B and 2C wherein a first and second matrix are respectively shown. In FIG. 2B, a first matrix 200B shows four input elements. Assuming the user desires to select input elements based on the generic element at location (0,0). Upon the user uttering the coordinates (0,0), a second matrix 200C containing different forms of the selected generic element is shown. The user can then choose a desired form by uttering the row and column label. Once the desired form is selected, the second matrix 200C disappears and the user can continue selecting other input elements from the first matrix 200D.

It is noted that it is not necessary that every input element in the first matrix 200B has a second matrix associated with it. Further, it is clear that the secondary matrix can also trigger a third matrix to be presented, and the third matrix can trigger a fourth matrix and so on. This cycle can be continued as needed depending on the user application.

In the above example, the display used for showing the input elements 206 to the user can be either an electronic display or a hardcopy material display such as a piece of paper, printed signboard, plastic sheet, metal plate, concrete, block of wood, and the like material upon which information can be presented thereon. Therefore, in the case of a hardcopy material display, the “next screen” element 206B as seen in FIG. 2A can be replaced by a reference pointing the user to refer to a separate display having the indicated reference for the next lot or group of input elements.

In another embodiment, a matrix 200D uses colors as column-index 210 and row-index 216. Using colors as indices is beneficial for illiterate users, users with limited knowledge of the language, such as tourists, or young users who have yet to learn to read. Take for example, a tourist in a foreign country looking for a hotel to stay. The tourist can simply select the hotel input element 224 by uttering the coordinates of the hotel input element 224 in term of colors. In this case, the coordinates are (BLUE 214, RED 220).

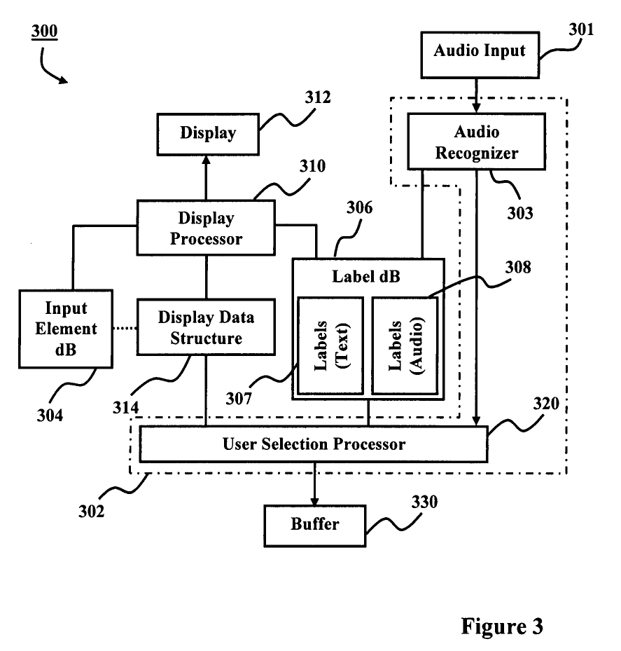

A system 300 for enabling voice communication with a machine according to an embodiment is shown in FIG. 3. The system 300 includes an input processor 302, a label database 306 containing pre-defined labels, and a display processor 310. The pre-defined labels can be colors, numbers, characters, words, images, symbols, and the like easy to recognize and distinct forms of referencing when input as audio to the machine. The pre-defined labels include labels in text form 307 and audio form 308. Each of the text form labels 307 corresponds to an audio form label 308.

The input processor 302 includes an audio recognizer 303 and a user selection processor 320. The audio recognizer 303 receives an audio input 301 from a user and processes the audio input 301 to provide a text equivalent which is subsequently used by the user selection processor 320. The audio recognizer 303 processes speech inputs from the user. For example, for speech inputs, typically an utterance from the user, the audio recognizer 303 processes the speech inputs which include matching the speech inputs with the labels in audio form 308. Upon finding a match, a text equivalent of the speech inputs is obtained from the text form labels 307 and is provided to the user selection processor 320 for further processing. The audio recognizer 303 is a known art. Therefore, the operation details and components thereof are not further described. Any number of variations and techniques of the audio recognizer 303 can be used.

The display processor 310 retrieves pre-defined input elements from an input element database 304 and arranges the input elements in a matrix on a display 312. The matrix includes a coordinate system having a column-index and a row-index. The column and row indices are pre-defined labels provided in the label database 306. Examples of different matrices are shown in FIGS. 2(A-D). In an embodiment, a matrix 200A uses cardinal numbers as indices for column-index 202 and row-index 204 as shown in FIG. 2A. To select an input element 206 from the matrix 200A, the user simply utters the coordinates of the desired input element 206 shown on the display 312.

The display processor 310 also creates a display data structure 314 every time a matrix is generated for display. The display data structure 314 contains information about the matrix displayed. The information includes the labels used for the column and row indices, the input elements and the coordinates or position of each of the input elements in the matrix. The display data structure 314 stores the information in text form. In the case where colors or symbols are used as indices, the display data structure 314 contains the equivalent texts representing the colors and symbols used. The display data structure 314 is subsequently used by the user selection processor 320 for determining the input elements selected by the user.

In an alternative embodiment, the display data structure 314 may store the information in audio form. Thus, if the labels used are words or phrases, the phonemes are stored, and if the labels used are sounds, the waveform features are stored. In this case, the audio recognizer simply passes the extracted phonemes or waveform features directly to the user selection processor 320 without first finding the text equivalent thereof.

The user selection processor 320 determines the input elements selected by the user by matching the inputs received from the audio recognizer 303 against the information in the display data structure 314. As described in the foregoing, the outputs received from the audio recognizer 303 can be either in text form or in phonemes or in waveform features depending on which of the embodiments of the display data structure 314 is used. Where the display data structure 314 stores the information of the matrix using text, the user selection processor 320 matches the text received from the audio recognizer 303 with the text in the display data structure 314 to decipher the user selected input elements. However, if the display data structure 314 stores the information of the matrix using audio, the user selection processor 320 matches the phonemes or waveform features received from the audio recognizer 303 with the phonemes or waveform features in the display data structure 314, respectively.

The output from the user selection processor 320 is stored in a buffer 330 for further processing depending on the intended application. Further, the output from the user selection processor 320 can be displayed on the display 312 as feedback to the user.

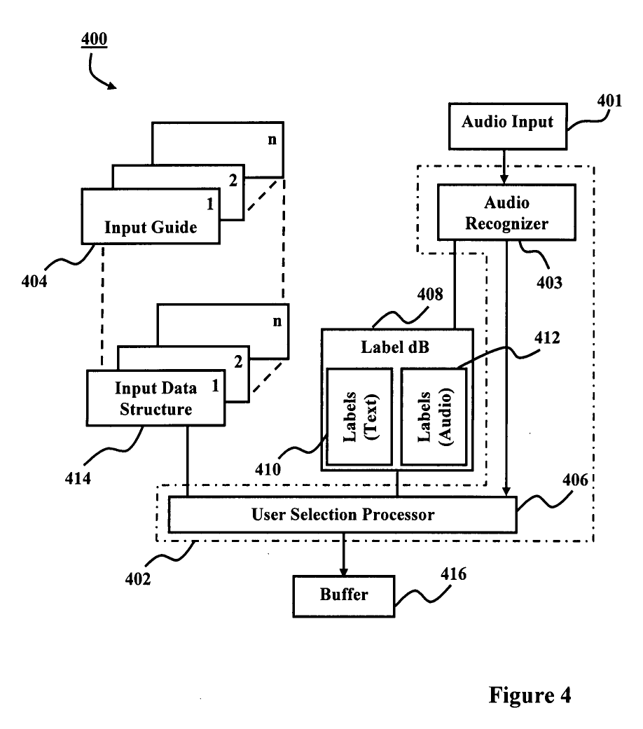

In an alternative embodiment, a system 400 for enabling voice communication with a machine is shown in FIG. 4. The system 400 includes an input processor 402, at least an input guide 404, and a label database 408 containing pre-defined labels. The pre-defined labels, as described in the foregoing, can be colors, numbers, characters, words, images, symbols, and the like easy to recognize and distinct forms of referencing when inputted as audio to the machine. The pre-defined labels include labels in text form 410 and audio form 412. The audio form labels 412 include phonemes for speech inputs and each audio form label 412 corresponds to a text form labels 410.

The input processor 402 includes an audio recognizer 403 and a user selection processor 406. The audio recognizer 403 receives an audio input 401 from a user and processes the audio input 401 to provide a text equivalent which is subsequently used by the user selection processor 406. The audio recognizer 403 processes speech inputs from the user. For example, for speech inputs, typically an utterance from the user, the audio recognizer 403 can extract phonemes from the speech inputs and matches the phonemes with the labels in audio form 412. Alternatively, the audio recognizer 403 can translate the speech inputs into text which is subsequently matched with the text form label 412. Upon finding a match, the answer is provided to the user selection processor 406 for further processing. The audio recognizer 403 is a known art. Therefore, the operation details and components thereof are not further described. Any number of variations and techniques of the audio recognizer 403 can be used.

The input guide 404 contains input elements, like the exemplary input elements shown in FIGS. 2A-2D, for users to make selections from. The input guide 404 can be displayed on an electronic device or on a media such as a piece of paper, a plastic sheet, a signboard, a metal plate, slap or block of concrete, a block of wood, and the like material upon which information can be presented. The input elements in the input guide 404 are arranged in a matrix or a table which includes a coordinate system including a column-index and a row index for identifying each of the input elements. The column and row indices are pre-defined labels and are provided in the label database 408.

The system 400 also includes at least an input data structure 414. The input data structure 414 is for containing information about the location of each of the input elements in the matrix in the input guide 404. Each input guide 404 has a corresponding input data structure 414. Similar to the display data structure 314 in FIG. 3 and described in the foregoing, the input data structure 414 can either use the text form labels 410 or the audio form labels 412 for storing the locations of the input elements in the matrix in the input guide 404. If the input data structure 414 uses the audio form labels 412, the system 400 does not require the label database 408 to have both the text form 410 and audio form 412 labels to function properly. Only the audio form 412 labels are needed.

The user selection processor 406 determines the input elements selected by the user by matching the inputs received from the audio recognizer 403 against the information in the input data structure 414. As described in the foregoing, the outputs received from the audio recognizer 403 can be either in text form or in phonemes or in waveform features depending on which of the embodiments of the input data structure 414 is used. Where the input data structure 414 stores the information of the matrix using text, the user selection processor 406 matches the text received from the audio recognizer 403 with the text in the input data structure 414 to decipher the user selected input elements. However, if the input data structure 314 stores the information of the matrix using audio, the user selection processor 406 matches the phonemes or waveform features received from the audio recognizer 403 with the phonemes or waveform features in the input data structure 414, respectively.

The output from the user selection processor 406 is stored in a buffer 416 for further processing depending on the intended application. Further, the output from the user selection processor 406 can be presented back to the user as a feedback in audio form through a speaker (not shown) coupled to the system 400.

In the foregoing, embodiments of the invention are described with reference to FIGS. 1-4. It is anticipated that individuals skilled in the art may make other modifications and equivalents thereto. Therefore, the foregoing description should not be taken as limiting the scope of the invention which is defined by the appended claims.

1. A method of voice communication with a machine comprising:
providing a first guide for containing input elements, wherein the input elements are arranged in a first arrangement comprising a coordinate system for locating the input elements; and
processing a user selection.

2. The method of claim 1 further comprising, upon processing the user selection, providing a second guide containing at least one input element disposed in a second arrangement.

3. The method of claim 1 further comprising, upon processing the user selection, providing a second guide containing at least one input element disposed in a second arrangement, wherein the at least one input element of the second guide relates to the selected input element of the first guide.

4. The method of claim 1, wherein providing the first guide comprises providing the first guide on a non-electronic display for interfacing with a user.

5. The method of claim 1, wherein providing the first guide comprises providing the first guide on an electronic display for interfacing with a user.

6. The method of claim 1 further comprising providing a data structure for referencing the input element in the first arrangement.

7. The method of claim 6, wherein processing the user selection comprises receiving an audio input and determining the selected input element from the audio input using the data structure.

8. The method of claim 6 further comprising providing pre-defined labels for use as indices of the coordinate system, the pre-defined labels of colors, images, symbols, and characters.

9. The method of claim 8, wherein providing pre-defined labels comprises providing the pre-defined labels in audio form.

10. The method of claim 9, wherein providing the data structure comprises using the data structure for referencing the coordinates of the input element in the first arrangement using the audio form labels.

11. The method of claim 10, wherein processing the user selection comprises receiving a set of coordinates in audio form and matching the coordinates with the audio form labels in the data structure to identify the selected input element.

12. The method of claim 8, wherein providing pre-defined labels comprises providing the pre-defined labels in an audio form and a text form, each audio form label corresponding to a text form label.

13. The method of claim 12, wherein providing the data structure comprises using the data structure for referencing the coordinates of the input element in the first arrangement using the text form labels.

14. The method of claim 13, wherein processing the user selection comprises
receiving a set of coordinates in audio form;
obtaining a corresponding set of coordinates in text form from the audio form; and
matching the corresponding coordinates in text form with the text form labels in the data structure to identify the selected input element.

15. A system for voice communication with a machine comprising:
a guide for containing at least one input element disposed in an arrangement, the arrangement having a coordinate system for locating the input element; and
a processor for processing a user selection.

16. The system of claim 15, wherein the guide comprises at least one of paper, signboard, metal plate, plastic sheet, concrete, and wood.

17. The system of claim 15 further comprising a data structure for locating the input element disposed in the arrangement.

18. The system of claim 17, wherein the processor processes the user selection by receiving an audio input and determining the selected input element from the audio input using the data structure.

19. The system of claim 17 further comprising a label database, the label database having labels for use as indices of the coordinate system, the labels comprising at least one of colors, images, symbols, and characters.

20. The system of claim 19, wherein the labels are provided in audio form.

21. The system of claim 20, wherein the data structure stores the location of the input element disposed in the arrangement using the audio form labels.

22. The system of claim 21, wherein the processor processes the user selection by receiving an audio input of a set of coordinates and matching the coordinates with the audio form labels in the data structure to identify the selected input element.

23. The system of claim 19, wherein the labels are provided in audio form and text form, each audio form label corresponding to a text form label.

24. The system of claim 23, wherein the data structure stores the location of the input element disposed in the arrangement using the text form labels.

25. The system of claim 24, wherein the processor processes the user selection by receiving an audio input of a set of coordinates; obtaining a text form equivalent of the audio input; and matching the text form with the text form labels in the data structure to identify the selected input element.

26. A system for voice communication with a machine comprising:
an input database for containing at least one input element;
a display processor for presenting the input element in a matrix, the matrix having a coordinate system for referencing the input element; and
a processor for processing a user selection.

27. The system of claim 26 further comprising a display for displaying the matrix for interfacing with a user.

28. The system of claim 26 further comprising a data structure for locating the input element disposed in the matrix.

29. The system of claim 28, wherein the processor processes the user selection by receiving an audio input of a set of coordinates and determining the selected input element from the audio input using the data structure.

30. The system of claim 28 further comprising a label database having labels for use as indices of the coordinate system, the labels comprising at least one of colors, images, symbols, and characters.

31. The system of claim 30, wherein the labels are provided in audio form.

32. The system of claim 31, wherein the data structure stores the location of the input element disposed in the matrix using the audio form labels.

33. The system of claim 32, wherein the input processor processes the user selection by receiving an audio input of a set of coordinates and matching the coordinates with the audio form labels in the data structure to identify the selected input element.

34. The system of claim 30, wherein the labels are provided in audio form and text form, each audio form label corresponding to a text form label.

35. The system of claim 34, wherein the data structure stores the location of the input element disposed in the matrix using the text form labels.

36. The system of claim 35, wherein the input processor processes the user selection by receiving an audio input of a set of coordinates; obtaining a corresponding set of coordinates in text form from the audio input; and matching the corresponding coordinates in text form with the text form labels in the data structure to identify the selected input element.
